(19) United States
(12) Patent Application Publication
(10) Pub. No.: US 2012/0052154 A1
(43) Pub. Date: Mar. 1, 2012

(54) INVERSE EMULSION AND USE THEREOF

(76) Inventors: Sandrine Cudre, Grand-Saconnex (CH); Eric Doelker, Conches (CH); Alan Parker, Metz-Tessy (FR)

(21) Appl. No.: 13/320,085

(22) PCT Filed: Jun. 7, 2010
(86) PCT No.: PCT/IB10/52515

§ 371 Date: Nov. 11, 2011

(30) Foreign Application Priority Data
Jun. 10, 2009 (IB) PCT/IB2009/052467

(51) Int. Cl. A23L 1/035; A23G 4/14; A23L 3/3454; A23L 2/44

(52) U.S. Cl. 426/3; 426/650; 426/590; 426/330

(57) ABSTRACT

The present invention relates to the flavors industry. More particularly, it relates to an inverse emulsion that includes a hydrophilic flavor or sweetener, lecithin, thaumatin, a polar solvent and a hydrophobic component. The invention also relates to the use of such an emulsion in flavored products and to a method for stabilizing an inverse emulsion by adding thaumatin to the dispersed phase of the emulsion.

### TECHNICAL FIELD

The present invention relates to the flavors industry. More particularly, it relates to an inverse emulsion comprising a hydrophilic flavor or sweetener, lecithin, thaumatin, a polar solvent and a hydrophobic component. The invention also relates to the use of such an emulsion in flavored products and to a method for stabilizing an inverse emulsion comprising adding thaumatin to the dispersed phase of the emulsion.

### PRIOR ART

Inverse emulsions are useful to include hydrophilic flavors or sweeteners into hydrophobic food products. It is therefore desirable to provide a new stable inverse emulsion.

Hydrophilic flavors can be dissolved in polar solvents such as propylene glycol, but usually not in water. Nevertheless, in inverse emulsions known to date, water is necessary for the stability of the emulsion. Since water is not a good solvent for hydrophilic flavors, it would be advantageous to provide inverse emulsions which are stable even when only low amounts of water are present or in the absence of water.

U.S. Pat. No. 4,786,491 describes an emulsion comprising thaumatin, lecithin, water and a flavoring ingredient. Nevertheless, the teaching of this document does not solve the above mentioned problem for two reasons. Firstly, the flavor is hydrophobic, whereas it is desirable to provide an emulsion to include a hydrophilic flavor or sweetener in a hydrophobic base. Secondly, the emulsions described in this document necessarily contain water. Moreover, propylene glycol, which is the most preferred polar solvent for use with hydrophilic flavors, is not mentioned.

It is desirable to provide inverse emulsions suitable for including hydrophilic flavors or sweeteners in hydrophobic edible bases. It would be further advantageous to provide such emulsions containing high amounts of a polar solvent such as propylene glycol and very low amounts of water or even no water, because hydrophilic flavors are dissolved more efficiently in solvents such as propylene glycol than in water.

### SUMMARY OF THE INVENTION

The present invention provides an unexpected solution to the above-mentioned problem. Indeed, the present inventors have surprisingly discovered that inverse emulsions comprising a flavor or sweetener, a polar solvent, a hydrophobic component and optionally water are stabilized by the addition of thaumatin. The inverse emulsion of the invention is stable even in the absence of water.

Therefore, the present invention provides an inverse emulsion comprising

(a) from 45 to 80% of a dispersed phase comprising

(i) from 0.2 to 1% of thaumatin;

(ii) from 10 to 68.8% of a polar solvent which is not water;

(iii) from 0 to 58.8% of water; and

(iv) from 1 to 30% of a hydrophilic flavor or sweetener;

(b) from 20 to 55% of a continuous phase comprising

(i) from 2 to 10% of lecithin; and

(ii) from 10 to 53% of a hydrophobic material;

all percentages being defined by weight, relative to the total weight of the emulsion.

The invention further provides a flavored product comprising an inverse emulsion as defined above.

In another aspect, the invention provides a method for stabilizing an inverse emulsion containing a hydrophilic flavor or sweetener, a polar solvent which is not water, lecithin, a hydrophobic component and optionally water, comprising adding to the dispersed phase of the emulsion from 0.2 to 1% by weight, relative to the total weight of the emulsion, of thaumatin.

### DETAILED DESCRIPTION

The present inventors have found that the combination of thaumatin efficiently stabilizes inverse emulsions, even in the absence of water. This is surprising and, to the best of our knowledge, unknown. When thaumatin is present, the droplet size distribution in the emulsion is reduced and the shelf life of the emulsion is increased. The maximum volume fraction of the aqueous phase and the hydrophilic flavor or sweetener load are also increased when thaumatin is present.

All percentages recited in the present description are intended by weight, relative to the total weight of the emulsion, unless otherwise indicated.

As “inverse emulsions”, we mean here an emulsion in which the internal (dispersed) phase is hydrophilic, whereas the external (continuous) phase is hydrophobic.

For the purpose of the present invention, a material is meant to be “hydrophilic” when its partition between propylene gylcol and medium chain triglyceride, in particular caprylic/capric triglyceride (sold under the trade name Neobee®) is at least 40:60, preferably at least 50:50. A material is meant to be “hydrophobic” when its partition between propylene gylcol and medium chain triglyceride, in particular caprylic/capric triglyceride (sold under the trade name Neobee®) is less than 40:60.

The skilled person can easily determine by routine experimentation, the partition between propylene glycol and caprylic/capric triglycerides of a particular flavor, sweetener or mixture thereof. Nevertheless, a suitable method for determining the partition is as follows.

An amount of 1 ml of caprylic/capric triglycerides and 1 ml of propylene glycol are placed in a glass tube. An amount of 1 ml of the flavor or sweetener is further added to the tube. The tube is then shaken at 10 rpm for 16 hours using the Test Tube Rotator 34528 from Snijders Scientific, Tilburg, Holland. The height of each phase is then measured using a Turbiscan MA 2000. The partition is calculated on the basis of the relation between the height of the hydrophilic phase (consisting of propylene glycol and a part of the flavor or sweetener) and the height of the hydrophobic phase (consisting of the caprylic/capric triglycerides and the rest of the flavor or sweetener).

The proportion of dispersed phase in the inverse emulsions of the invention is comprised between 45 and 80%. An even larger proportion of dispersed phase comprised between 60 and 75% is even preferable because this parameter is essential to have a high hydrophilic flavor and/or sweetener load. The components of the dispersed phase are as defined below.

Thaumatin is a polypeptide of natural origin that is often used as a sweetener in flavoring compositions or in flavored products. Two different forms of thaumatin are known: thaumatin I and thaumatin II. For the purpose of the present invention, the term “thaumatin” encompasses thaumatin I, thaumatin II and mixtures thereof, as well as modified forms of these proteins.

Even very low amounts of thaumatin are sufficient to stabilize the emulsions of the invention, but higher concentrations can be used if a sweetening effect is desired. Typically, thaumatin can be present in the emulsions of the invention in an amount comprised between 0.2 and 1%. Narrower ranges can be defined, depending on the products in which the emulsion is intended to be used and depending on the desired sweetening effect. For example, concentrations ranging from 0.25% to 0.5% are preferred. Thaumatin is commercially available for example from Overseal Natural Ingredients, Talin®, Beneo-Palatinit or MP Biomedicals.

Any polar solvent of current use in flavoring compositions can be used in the emulsion of the invention. Preferably the polar solvent is totally water-miscible. One particularly suitable water-miscible solvent is propylene glycol.

Water is an optional ingredient of the dispersed phase. The emulsion is perfectly stable even in the absence of water but, if desired, water can be added without any adverse effect on the stability of the emulsion. Preferably, the emulsion of the invention comprises less than 2.5% of water. More preferably, it is free of water.

The amounts of polar solvent and of water present in the dispersed phase are not key factors for the stability of the emulsion. The concentration of these two components can vary within a wide range of values and can be adjusted by the person skilled in the art by the way of routine experimentation, on the basis of the desired concentration of flavor and of the nature of the target application.

The flavor can be in the form of a single flavoring compound or of a mixture of flavoring compounds. The phrase “flavoring compound” has the usual meaning in the art in that it is a compound that imparts a hedonic effect, i.e. is able to impart or modify in a pleasant way the taste of a preparation, and not just as imparting a taste.

Sweeteners can also advantageously be present in the inverse emulsions of the invention, alone or admixed with flavoring ingredients.

The flavoring compounds or sweeteners that can be used in the dispersed phase are hydrophilic, as defined above. These ingredients form a one phase solution with the polar solvent.

Within hydrophilic flavoring compounds and sweeteners, the suitable ones are selected by the skilled person on the basis of its general knowledge and according to the intended use or application and the desired organoleptic effect.

The term “flavor”, in the context of the present invention, may refer to a single flavoring molecule, or to a composition comprising several flavoring agents. Preferably, the term flavor composition refers to a composition of at least two flavor molecules. The term flavor also includes compounds that are perceived by mediation of the trigeminal nerve, such as cooling, salivating, pungent and tingling compounds, for example. Typically, the flavoring compounds belong to chemical classes as varied as alcohols, aldehydes, ketones, esters, ethers, acetates, nitriles, terpene hydrocarbons, nitrogenous or sulphurous heterocyclic compounds and essential oils. They can be of natural or synthetic origin. Many of these compounds are in any case listed in reference texts such as the book by S. Arctander, Perfume and Flavor Chemicals, 1969, Montclair, N.J., USA, or its more recent versions, or in other works of a similar nature, as well as in the abundant patent literature in the field of flavor.

It is particularly advantageous that the at least one flavoring compound used in the inverse emulsion of the invention is a natural flavor.

Flavoring compounds, which are often volatile, can advantageously be encapsulated in order to limit their loss. Any encapsulation technique known in the art can be used to encapsulate these flavoring compounds, for example spray drying or extrusion.

The total amount of continuous phase present in the inverse emulsion of the invention is determined by the desired proportion of dispersed phase, as explained above. Therefore, the continuous phase typically represents from 20 to 55%, preferably from 25 to 40% of the emulsion. The essential ingredients of the continuous phase are lecithin and a hydrophobic component.

Lecithin is usually defined as a complex mixture of acetone-insoluble phosphatides, which consists chiefly of phosphatidyl choline, phosphatidyl ethanolamine, phosphatidyl serine, and phosphatidyl inositol, combined with various amounts of other substances such as triglycerides, fatty acids, and carbohydrates, as separated from the crude vegetable oil source. For the purpose of the present invention, “lecithin” means any mixture of at least two of the above-mentioned phospholipids, more preferably any mixture of at least three of the abovementioned phospholipids. The term “lecithin” further includes modified forms of lecithin such as hydroxylated or enzymatically modified lecithins.

Particularly efficient lecithins for use in the present invention include those commercialized under the names Alcolec® F-100 (origin American Lecithin), Adlec® soy (origin: ADM) and Epikuron 200 (origin: Cargill).

Lecithin is present in the emulsion in relatively low amounts, typically comprised between 2 and 10% and preferably between 5 and 10%.

The hydrophobic component can be a hydrophobic solvent, a hydrophobic flavoring compound or a mixture thereof.

As “hydrophobic solvent” it is meant any solvent which is hydrophobic, as defined above, and which is not miscible with water. Medium chain triglyceride (for example caprylic/capric triglycerides sold under the trade name Neobee®) and Triacetin are examples of such hydrophobic solvents. Neobee® is preferred. Neobee® M5 being the most preferred.

As “hydrophobic flavor” it is meant a single flavoring compound or a mixture of flavoring compounds being hydrophobic, as defined above. The hydrophobic component can also be a mixture of a hydrophobic flavor and a hydrophobic solvent.

The hydrophobic component is present in an amount comprised between 10 and 53% and preferably in an amount of 15 to 50%.

Optionally, the emulsion of the invention may also comprise flavor adjuvants. By “flavor adjuvant”, it is meant an ingredient capable of imparting additional added benefit such as a colour, a particular light resistance, chemical stability, and so on. A detailed description of the nature and type of adjuvants commonly used in flavoring bases cannot be exhaustive, though such ingredients are well known to a person skilled in the art.

The emulsion of the invention can be prepared using any method known to the person skilled in the art for the preparation of inverse emulsions, such as low shear mixing, high shear mixing, sonication or homogenization.

According to a preferred aspect of the invention, the emulsion is stable for at least one month at 25° C. The emulsion is considered as stable when no oil layer is formed or when the formed oil layer represents not more than 10% of the total volume of the emulsion. The volume of the oil layer can easily be measured using a Turbiscan apparatus such as the Turbiscan MA 2000.

The inverse emulsion of the invention, as described above can advantageously be used in any food product or beverage. It is more advantageously used in food products or beverages which are hydrophobic or oil-based products. As examples of such products, one can cite in particular savoury foods and chewing gums, among which chewing gums are preferred. “Savoury foods” are defined as any food product having a salty or spicy taste is encompassed by the term “savoury”. Snacks are a particular example of such savoury food products.

The amount in which the emulsion of the invention can be added in the product of the invention varies within a wide range of values. These values are dependent on the nature of the article to be flavored and on the desired organoleptic effect as well as the nature of the co-ingredients in a given base when the emulsion according to the invention is mixed with flavoring co-ingredients, solvents or additives commonly used in the art. The amount of the emulsion of the invention that is included in the final flavored product depends essentially on the desired taste.

In the flavored products of the invention, the emulsion can be admixed with a flavor carrier. By “flavor carrier”, it is meant a material that is substantially neutral in terms of flavor, such that it does not significantly alter the organoleptic properties of flavoring ingredients. The carrier may be a liquid or a solid.

Suitable liquid carriers include, for example, a solvent commonly used in flavors. Suitable solvents include, for example, propylene glycol, glycerin, triacetine, triethyl citrate, benzylic alcohol, ethanol, vegetal oils or terpenes. This list is non-exhaustive and the skilled person will readily understand that other solvents may be suitable for use in the present invention.

Suitable solid carriers include, for example, absorbing gums or polymers, or even encapsulating materials. Examples of such materials include wall-forming and plasticizing materials, such as mono, di- or trisaccharides, natural or modified starches, hydrocolloids, cellulose derivatives, polyvinyl acetates, polyvinylalcohols, proteins or pectins, or the materials cited in reference texts such as H. Scherz, Hydrokolloids: Stabilisatoren, Dickungs- and Geliermittel in Lebensmittel, Band 2 der Schriftenreihe Lebensmittelchemie, Lebensmittelqualität, Behr's Verlag GmbH & Co., Hamburg, 1996. Encapsulation is a well known process to a person skilled in the art, and may be performed, for instance, using techniques such as spray-drying, agglomeration and extrusion; or it may consist of a coating encapsulation, such as simple or complex coacervation techniques.

The flavored product can also comprise a flavor base and/or a flavor adjuvant. A “flavor adjuvant” is as defined above. By “flavor base”, it is meant a composition comprising at least one flavoring compound, as defined above.

In a further aspect, the invention relates to a method for stabilizing an inverse emulsion containing a hydrophilic flavor, a polar solvent which is not water, lecithin and a hydrophobic component, comprising adding thaumatin to the dispersed phase. All components of the emulsion are as defined above.

Typically, thaumatin can be added in an amount comprised between 0.2 and 1%. Narrower ranges can be defined, depending on the products in which the emulsion is intended to be used and the desired organoleptic effect. For example, concentrations ranging from 0.25 to 0.5% can be selected.

The obtained emulsion is particularly stable. This is surprising because inverse emulsions containing high fractions of propylene glycol are not sufficiently stabilized by lecithin alone. This is even more surprising because thaumatin has never been described as having emulsifying properties. The present invention reveals that the mixture of lecithin and thaumatin is essential for the stabilisation of the above-described emulsions. Lecithin and thaumatin act in synergy to stabilise the inverse emulsion, even with high concentrations of propylene glycol and in the absence of water.

### DESCRIPTION OF THE DRAWINGS

FIG. 1: Microscopy picture of the inverse emulsion of Example 1 (Composition A).

FIG. 2: Photograph showing Composition A (two bottles on the left) and Composition B (two bottles on the right).

FIG. 3: Photograph showing Composition E after 2 months storage at 25° C.

### EXAMPLES

The invention will now be described in further detail by way of the following Examples.

### Example 1

### Inverse Emulsion According to the Invention: Evidence of the Stabilizing Effect of Thaumatin

Composition A, in the form of an inverse emulsion, comprised the following ingredients:

TABLE 1
Composition A

| Ingredients | % |
|---|---|
| Apple flavor¹⁾ | 10 |
| Propylene glycol | 60 |
| Thaumatin²⁾ | 5 |
| Total dispersed phase | 75 |
| Hydrophobic component³⁾ | 20 |
| Lecithin⁴⁾ | 5 |
| Total continuous phase | 25 |
| Total both phases | 100 |

¹⁾Mixture of flavoring ingredients having an apple taste and a partition between propylene glycol and Neobee ® M5 of 51.9:48.1, origin: Firmenich SA.
²⁾Thaumatin Nat 987499, 5% solution of thaumatin in aqueous propylene glycol, origin: Overseal Natural Ingredients
³⁾Neobee ® M5, origin: Stepan
⁴⁾Epikuron 200, origin: Cargill

Two identical samples of Composition A were prepared as follows. Firstly, the hydrophilic (dispersed) phase was prepared by dissolving 0.25 g of thaumatin in 3 g of propylene glycol. This solution was stirred during 15 minutes with a magnetic stirrer and then 0.5 g of apple flavor was added under magnetic stirring. The solution was then stirred for 15 more minutes.

The hydrophobic (continuous) phase was prepared by dissolving 0.25 g of Epikuron 200 (origin: Cargill) in 1 g of Neobee® M 5 (origin: Stepan). This solution was stirred for 30 minutes with a magnetic stirrer.

The hydrophilic phase was then added over a period of 30 minutes under magnetic stirring. The mixture was stirred for 5 more minutes after addition of the hydrophilic phase.

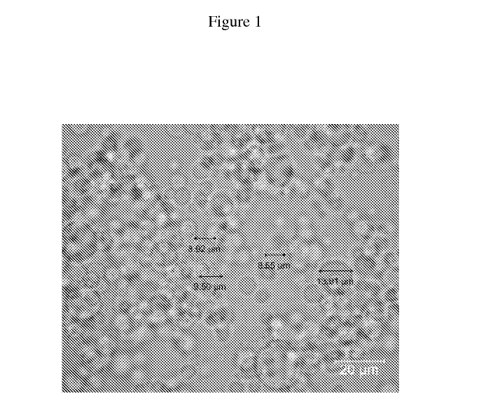

The microscopy image of the obtained inverse emulsion after one day of storage at 25° C. is shown in FIG. 1.

Composition B comprised the following ingredients:

TABLE 2
Composition B

| Ingredients | % |
|---|---|
| Apple flavor¹⁾ | 10 |
| Propylene glycol | 65 |
| Total dispersed phase | 75 |
| Hydrophobic component²⁾ | 20 |
| Lecithin³⁾ | 5 |
| Total continuous phase | 25 |
| Total both phases | 100 |

¹⁾Mixture of flavoring ingredients having an apple taste and a partition between propylene glycol and Neobee ® M5 of 51.9:48.1, origin: Firmenich SA.
²⁾Neobee ® M5, origin: Stepan
³⁾Epikuron 200, origin: Cargill

In composition B, thaumatin has been replaced by propylene glycol but all other components are the same as in composition A and the proportions of dispersed and of continuous phase remained the same as for composition A.

Two identical samples of composition B were prepared as follows. Firstly, 0.5 g of apple flavor were added to 3 g of propylene glycol under magnetic stirring. This solution was then stirred during 15 minutes with a magnetic stirrer.

The hydrophobic (continuous) phase was prepared by dissolving 0.25 g of Epikuron 200 (origin: Cargill) in 1 g of Neobee® M 5 (origin: Stepan). This solution was stirred for 30 minutes with a magnetic stirrer.

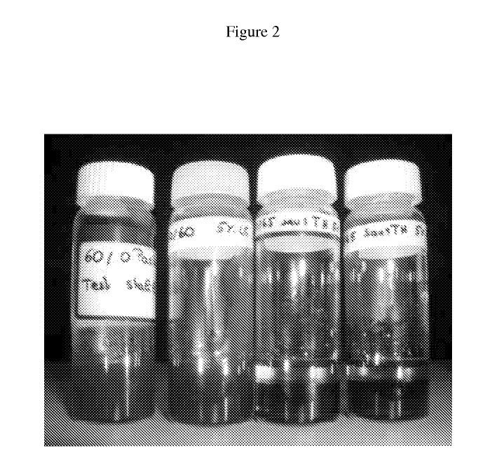

The hydrophilic phase was then added over a period of 30 minutes under magnetic stirring. After addition of the hydrophilic phase, the mixture was stirred for 5 more minutes. No emulsion was formed unlike in Composition A. The photography of FIG. 2, taken immediately after the preparation of the emulsion, shows a clear difference between Composition A (two samples on the left) and Composition B (two samples on the right). In both samples of Composition B, two phases are observed (light grey on the top and dark grey at the bottom), whereas no phase separation is observed in the samples of Composition A.

### Example 2

### Inverse Emulsion According to the Invention

Composition C, in the form of an inverse emulsion, comprised the following ingredients:

TABLE 3
Composition C

| Ingredients | % |
|---|---|
| Water melon flavor¹⁾ | 20 |
| Propylene glycol | 20 |
| Thaumatin²⁾ | 5 |
| Total dispersed phase | 45 |
| Hydrophobic component³⁾ | 45 |
| Lecithin⁴⁾ | 10 |
| Total continuous phase | 55 |
| Total both phases | 100 |

¹⁾Mixture of flavoring ingredients having a water melon taste and a partition between propylene glycol and Neobee ® M5 of 55.5:44.4, origin: Firmenich SA.
²⁾Thaumatin Nat 987499, 5% solution of thaumatin in aqueous propylene glycol, origin: Overseal Natural Ingredients
³⁾Neobee ® M5, origin: Stepan
⁴⁾Epikuron 200, origin: Cargill

Composition C was prepared as follows. Firstly, the hydrophilic (dispersed) phase was prepared by dissolving 0.25 g of thaumatin in 1 g of propylene glycol. This solution was stirred during 15 minutes with a magnetic stirrer and then 1 g of water melon flavor was added under magnetic stirring. The solution then was stirred for 15 more minutes. The hydrophobic (continuous) phase was prepared by dissolving 0.5 g of Epikuron 200 (origin: Cargill) in 2.25 g of Neobee® M 5 (origin: Stepan). This solution was stirred for 30 minutes with a magnetic stirrer.

The hydrophilic phase was then added over a period of 30 minutes under magnetic stirring. After addition of the hydrophilic phase, the mixture was stirred for 5 more minutes.

An inverse emulsion was formed.

### Example 3

### Inverse Emulsion According to the Invention

Composition D, in the form of an inverse emulsion, comprised the following ingredients:

TABLE 4
Composition D

| Ingredients | % |
|---|---|
| Water melon flavor¹⁾ | 20 |
| Propylene glycol | 20 |
| Thaumatin²⁾ | 5 |
| Total dispersed phase | 45 |
| Hydrophobic component³⁾ | 50 |
| Lecithin⁴⁾ | 5 |
| Total continuous phase | 55 |
| Total both phases | 100 |

¹⁾Mixture of flavoring ingredients having a water melon taste and a partition between propylene glycol and Neobee ® M5 of 55.5:44.4, origin: Firmenich SA.
²⁾Thaumatin Nat 987499, 5% solution of thaumatin in aqueous propylene glycol, origin: Overseal Natural Ingredients
³⁾Neobee ® M5, origin: Stepan
⁴⁾Epikuron 200, origin: Cargill

Composition D was prepared as follows. Firstly, the hydrophilic (dispersed) phase was prepared by dissolving 0.25 g of thaumatin in 1 g of propylene glycol. This solution was stirred during 15 minutes with a magnetic stirrer and then 1 g of water melon flavor was added under magnetic stirring. The solution was then stirred for 15 more minutes.

The hydrophobic (continuous) phase was prepared by dissolving 0.25 g of Epikuron 200 (origin: Cargill) in 2.5 g of Neobee® M 5 (origin: Stepan). This solution was stirred for 30 minutes with a magnetic stirrer.

The hydrophilic phase was then added over a period of 30 minutes under magnetic stirring. After addition of the hydrophilic phase, the mixture was stirred for 5 more minutes.

An inverse emulsion was formed.

### Example 4

### Inverse Emulsion According to the Invention

Composition E, in the form of an inverse emulsion, comprised the following ingredients:

TABLE 5
Composition E

| Ingredients | % |
|---|---|
| Sucralose¹⁾ | 14 |
| Propylene glycol | 51 |
| Thaumatin²⁾ | 5 |
| Total dispersed phase | 70 |
| Hydrophobic component³⁾ | 28 |
| Lecithin⁴⁾ | 2 |
| Total continuous phase | 30 |
| Total both phases | 100 |

¹⁾Origin: Firmenich SA
²⁾Thaumatin Nat 987499, 5% solution of thaumatin in aqueous propylene glycol, origin: Overseal Natural Ingredients
³⁾Neobee ® M5, origin: Stepan
⁴⁾Epikuron 200, origin: Cargill

Composition E was prepared as follows. Firstly, the hydrophilic (dispersed) phase was prepared by dissolving 1.5 g of thaumatin in 15.3 g of propylene glycol. This solution was stirred during 15 minutes with a magnetic stirrer and then 4.2 g of sucralose were added under magnetic stirring. The solution was then stirred for 15 more minutes.

The hydrophobic (continuous) phase was prepared by dissolving 0.6 g of Epikuron 200 (origin: Cargill) in 8.4 g of Neobee® M 5 (origin: Stepan). This solution was stirred for 30 minutes with a magnetic stirrer.

The hydrophilic phase was then added to the hydrophobic phase over a period of 10 minutes under stirring with a propeller at 500 rpm. After addition of the hydrophilic phase, the mixture was stirred for 5 more minutes at the same speed.

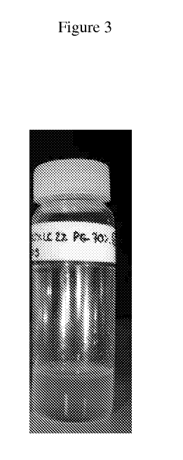

An inverse emulsion was formed. Composition E was stored at 25° C. during 2 months. The inverse emulsion remained stable during this period and no phase separation was observed, as shown in FIG. 3.

### Example 5

### Chewing Gum Containing the Inverse Emulsion of the Invention and Sensory Analysis

Two samples of chewing gum were prepared: Chewing gum A (a control prepared with pure sucralose) and Chewing gum B (a test sample prepared with the inverse emulsion of example 4 (Composition E)). Both samples had a final concentration of sucralose of 0.1%. First of all, an unflavored chewing gum was prepared with the following ingredients in the amounts indicated.

TABLE 6
Unflavored chewing gum

| Ingredients | wt % |
|---|---|
| Solsona T Gum Base¹⁾ | 12.46 |
| Vega Gum Base¹⁾ | 12.46 |
| Crystalline sorbitol P60W | 60.8 |
| Maltitol Syrup | 10.3 |
| Glycerin | 3.98 |
| Total | 100 |

¹⁾Origin: Cafosa

A Sigma-blade mixer was pre-heated to 45-50° C. and half of the Crystalline sorbitol P60W, of the Maltitol Syrup and of the Glycerin was added. The Solsona T Gum Base and the Vega Gum Base were pre-heated to 60-65° C. and added to the mixer. Mixing was carried out for approximately 4 minutes. The remaining Crystalline sorbitol P60W, Maltitol Syrup and Glycerin were added and mixing continued for a further 4 minutes.

The unflavored chewing gum prepared above was then flavored and sweetened to provide the following chewing gum compositions:

TABLE 7
Composition of Chewing gum A and Chewing gum B

| | | |
|---|---|---|
| | Chewing gum A | Chewing gum B |
| | (control) | (test) |
| Ingredients | wt % | wt % |

| | | |
|---|---|---|
| Unflavored Chewing Gum | 98.30 | 93.69 |
| Strawberry Flavor¹⁾ | 0.80 | 0.80 |
| Citric acid | 0.80 | 0.80 |
| Sucralose²⁾ | 0.10 | — |
| Composition E | — | 0.71 |

¹⁾Mixture of flavoring ingredients having a strawberry tase, origin: Firmenich SA, Geneva, Switzerland
²⁾Origin: Firmenich SA, Geneva, Switzerland

For Chewing gum A, the sweetener was added to the unflavored chewing gum preparation and blended for approximately 2 minutes. The flavor was then added and blended continuously for 2-4 minutes.

For Chewing gum B, Emulsion E was added and blended continuously for a further 2 minutes.

The sweetened chewing gums A and B were discharged, laminated and cut into sticks or slabs.

Six trained panellists were asked to assess the sweetness of Chewing gum A and Chewing gum B after a chewing time of 30, 60 an 120 s. The samples were presented on a blind test basis and following a balanced presentation order. The panellists were asked to rate the sweetness of the samples on a scale ranging from 0 to 10, where 10 is the most intense sweetness perception and 0 is no sweetness perception.

After 30 seconds, the panellists perceived Chewing gum A sweeter than chewing gum B, whereas after 60 and 120 seconds all panellists perceived Chewing gum B as significantly sweeter than Chewing gum A. This sensory analysis indicates that the long lastingness of the sweetness is improved when sucralose is added to the chewing gum base in the form of an inverse emulsion of the invention, instead of being incorporated as is.

1.-14. (canceled)

15. An inverse emulsion comprising:
(a) from 45 to 80% of a dispersed phase comprising:
(i) from 0.2 to 1% of thaumatin;
(ii) from 10 to 68.8% of a polar solvent other than water;
(iii) from 0 to 58.8% of water; and
(iv) from 1 to 30% of a hydrophilic flavor or sweetener;
(b) from 20 to 55% of a continuous phase comprising:
(i) from 2 to 10% of lecithin; and
(ii) from 18 to 53% of a hydrophobic material;
all percentages being defined by weight, relative to the total weight of the emulsion.

16. The inverse emulsion according to claim 15, comprising from 60 to 75% by weight of dispersed phase and from 25 to 40% by weight of continuous phase, relative to the total weight of the emulsion.

17. The inverse emulsion according to claim 15, wherein the dispersed phase comprises from 0.25 to 0.5% by weight, relative to the total weight of the emulsion, of thaumatin.

18. The inverse emulsion according to claim 15, wherein the polar solvent is completely water-miscible.

19. The inverse emulsion according to claim 15, wherein the polar solvent is propylene glycol.

20. The inverse emulsion according to claim 15, wherein the emulsion includes water but in an amount of less than 2.5% by weight, relative to the total weight of the emulsion.

21. The inverse emulsion according to claim 15, wherein the emulsion is free of water.

22. The inverse emulsion according to claim 16, comprising lecithin in an amount of from 5 to 10% by weight, relative to the total weight of the emulsion.

23. The inverse emulsion according to claim 16, wherein either an oil layer of not more than 10% or no oil layer is formed after one month storage at 25° C.

24. A food or a beverage comprising an inverse emulsion comprising:
(a) from 45 to 80% of a dispersed phase comprising:
(i) from 0.2 to 1% of thaumatin;
(ii) from 10 to 68.8% of a polar solvent other than water;
(iii) from 0 to 58.8% of water; and
(iv) from 1 to 30% of a hydrophilic flavor or sweetener;
(b) from 20 to 55% of a continuous phase comprising:
(i) from 2 to 10% of lecithin; and
(ii) from 18 to 53% of a hydrophobic material;
all percentages being defined by weight, relative to the total weight of the emulsion.

25. The food or a beverage according to claim 24, wherein the food or beverage is hydrophobic.

26. The food according to claim 25, wherein the food is a savory food or a chewing gum.

27. A method for stabilizing an inverse emulsion containing a hydrophilic flavor or sweetener, a polar solvent other than water, lecithin and optionally water, which comprises adding to the dispersed phase of the emulsion from 0.2 to 1% by weight, relative to the total weight of the emulsion, of thaumatin.

28. The method according to claim 27, wherein the thaumatin is added in an amount of from 0.25 to 0.5% by weight, relative to the total weight of the emulsion.
